(19) United States
(12) Patent Application Publication
(10) Pub. No.: US 2020/0010081 A1
(43) Pub. Date: Jan. 9, 2020

(54) AUTONOMOUS VEHICLE FOR PREVENTING COLLISIONS EFFECTIVELY, APPARATUS AND METHOD FOR CONTROLLING THE AUTONOMOUS VEHICLE

(71) Applicant: LG ELECTRONICS INC., Seoul (KR)

(72) Inventor: Chong Ook YOON, Seoul (KR)

(73) Assignee: LG ELECTRONICS INC., Seoul (KR)

(21) Appl. No.: 16/557,012

(22) Filed: Aug. 30, 2019

(30) Foreign Application Priority Data
Aug. 14, 2019 (KR) 10-2019-0099549

(51) Int. Cl. B60W 30/095; B60W 30/09; G05D 1/02; G01S 17/93

(52) U.S. Cl. CPC B60W 30/0956; G01S 17/93; G05D 1/021; B60W 30/09

(57) ABSTRACT

Disclosed herein are an autonomous vehicle for preventing collisions effectively, and an apparatus and a method for controlling the autonomous vehicle. According to the autonomous vehicle, and the apparatus and the method for controlling the autonomous vehicle of the present disclosure, an area to which the vehicle has to move to avoid a collision may be preset through simple data before the collision at the same time as driving information is generated for regular autonomous driving, and when the collision occurrence is predicted, the collision is prevented by allowing the vehicle to move to the preset collision-avoidance area.

An autonomous vehicle, to which the present disclosure is applied, may be a vehicle that can drive itself to a destination without operations of a user. In this case, the autonomous vehicle may be linked with any artificial intelligence (AI) modules, any drones, any unmanned aerial vehicles, any robots, any augmented reality (AR) modules, any virtual reality (VR) modules, any 5th generation (5G) mobile communication devices, and the like.

### CROSS-REFERENCE TO RELATED APPLICATION

This application claims priority to and the benefit of Korean Patent Application No. 10-2019-0099549, filed in the Republic of Korea on, August 14, the disclosure of which is incorporated herein by reference in its entirety.

### BACKGROUND

### 1. Field of the Invention

The present disclosure relates to an autonomous vehicle for preventing collisions effectively, and an apparatus and a method for controlling the autonomous vehicle.

### 2. Description of Related Art

A vehicle is a device for moving a user in a direction desired by the user. Typically, the vehicle may be an automobile.

In recent years, electronics manufacturers as well as existing automobile manufacturers focus their attention on developing autonomous vehicles. Autonomous vehicles perform autonomous driving by communicating with an external device, e.g., a control server, or by recognizing and determining their surroundings through various sensors attached to them.

Meanwhile, there is a possibility that the autonomous vehicles collide with other vehicles. Conventional autonomous vehicles fail to prevent collisions with other vehicles because it takes much time for them to predict a collision and perform an operation of avoiding the collision.

### SUMMARY OF THE INVENTION

One objective of the present disclosure is to provide an autonomous vehicle, and an apparatus and a method for controlling the autonomous vehicle that can minimize time spent on predicting a collision and performing an operation of avoiding the collision, thereby performing the operation of avoiding the collision fast.

Another objective of the present disclosure is to provide an autonomous vehicle, and an apparatus and a method for controlling the autonomous vehicle capable of preventing a secondary collision that can occur when the autonomous vehicle avoids a collision.

Objectives of the present disclosure are not limited to what has been described. Additionally, other objectives and advantages that have not been mentioned may be clearly understood from the following description and may be more clearly understood from embodiments. Further, it will be understood that the objectives and advantages of the present disclosure may be realized via means and a combination thereof that are described in the appended claims.

An autonomous vehicle according to an embodiment includes a camera configured to acquire an image frame near a vehicle performing autonomous driving, a recognizer configured to recognize first information that is state information on at least one object near the vehicle, second information that is state information on at least one space near the vehicle, and third information that is state information on at least one line near the vehicle, on the basis of the image frame, a first driving-information generator configured to generate first driving information for normal driving of the vehicle by combining the first information, the second information and the third information, a second driving-information generator configured to predict the occurrence of a collision of the vehicle using the first information, the second information and the third information, and configured to generate second driving information for collision-prevention driving when the collision occurrence is predicted, and a controller configured to control driving of the vehicle using the second driving information when the collision occurrence is predicted, and to control driving of the vehicle using the first driving information when the collision occurrence is not predicted.

An apparatus for controlling an autonomous vehicle according to an embodiment includes a recognizer configured to recognize first information that is state information on at least one object near the vehicle, second information that is state information on at least one space near the vehicle, and third information that is state information on at least one line near the vehicle, on the basis of an image frame acquired near the vehicle, a first driving-information generator configured to generate first driving information for normal driving of the vehicle by combining the first information, the second information and the third information, a second driving-information generator configured to predict the occurrence of a collision of the vehicle using the first information, the second information and the third information, and configured to generate second driving information for collision-prevention driving when the collision occurrence is predicted, and a controller configured to control driving of the vehicle using the second driving information when the collision occurrence is predicted, and configured to control driving of the vehicle using the first driving information when the collision occurrence is not predicted.

A method for controlling an autonomous vehicle according to an embodiment includes recognizing first information that is state information on at least one object near the vehicle, second information that state information on at least one space near the vehicle, and third information that is state information on at least one line near the vehicle, on the basis of an image frame acquired near the vehicle, generating first driving information for normal driving of the vehicle by combining the first information, the second information and the third information, predicting the occurrence of a collision of the vehicle using the first information, the second information and the third information and generating second driving information for collision-prevention driving when the collision occurrence is predicted, and controlling driving of the vehicle using the second driving information when the collision occurrence is predicted, and controlling driving of the vehicle using the first driving information when the collision occurrence is not predicted.

The present disclosure may perform an operation of avoiding a collision fast by minimizing time spent on predicting the collision and performing the operation of avoiding the collision.

Additionally, the present disclosure may prevent a secondary collision that can occur when a vehicle avoids a collision.

Effects of the present disclosure are not limited to what has been described, and various effects may be readily drawn from the configuration of the disclosure by one having ordinary skill in the art.

### BRIEF DESCRIPTION OF THE DRAWINGS

FIG. 1 is a view illustrating an example of basic operations of an autonomous vehicle and a 5G network in a 5G communication system.

FIG. 2 is a view illustrating an example of application operations of an autonomous vehicle and a 5G network in a 5G communication system.

FIGS. 3 to 6 are views illustrating an example of operations of an autonomous vehicle using 5G communication.

FIGS. 7 and 8 are schematic block diagrams illustrating an autonomous vehicle according to an embodiment.

FIGS. 9 and 10 are flow charts illustrating a method for autonomous driving of a vehicle according to an embodiment.

FIG. 11 is a view for describing an example of a candidate collision-avoidance area according to an embodiment.

FIG. 12 is a view illustrating a concept for preventing a secondary collision according to an embodiment.

### DETAILED DESCRIPTION

Hereinafter, embodiments of the present disclosure will be described in detail with reference to the drawings so that those skilled in the art to which the present disclosure pertains can easily implement the present disclosure. The present disclosure may be implemented in many different manners and is not limited to the embodiments described herein.

In order to clearly illustrate the present disclosure, technical explanation that is not directly related to the present disclosure may be omitted, and same or similar components are denoted by a same reference numeral throughout the specification. Further, some embodiments of the present disclosure will be described in detail with reference to the drawings. In adding reference numerals to components of each drawing, the same components may have the same reference numeral as possible even if they are displayed on different drawings. Further, in describing the present disclosure, a detailed description of related known configurations and functions will be omitted when it is determined that it may obscure the gist of the present disclosure.

In describing components of the present disclosure, it is possible to use the terms such as first, second, A, B, (a), and (b), etc. These terms are only intended to distinguish a component from another component, and a nature, an order, a sequence, or the number of the corresponding components is not limited by that term. When a component is described as being “connected,” “coupled” or “connected” to another component, the component may be directly connected or able to be connected to the other component; however, it is also to be understood that an additional component may be “interposed” between the two components, or the two components may be “connected,” “coupled” or “connected” through an additional component.

Further, with respect to embodiments of the present disclosure, for convenience of explanation, the present disclosure may be described by subdividing an individual component, but the components of the present disclosure may be implemented within a device or a module, or a component of the present disclosure may be implemented by being divided into a plurality of devices or modules.

A vehicle, to which the present disclosure is applied, may be an autonomous vehicle that can drive itself to a destination without operations of a user. In this case, the autonomous vehicle may be linked with any artificial intelligence (AI) modules, any drones, any unmanned aerial vehicles, any robots, any augmented reality (AR) modules, any virtual reality (VR) modules, any 5th generation (5G) mobile communication devices, and the like.

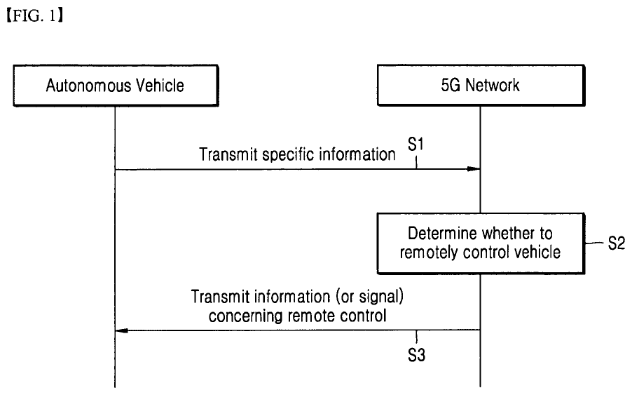

FIG. 1 is a view illustrating an example of basic operations for communication between an autonomous vehicle and a 5G network in a 5G communication system.

Herein, autonomous driving denotes a technology for allowing a vehicle to drive itself, and an autonomous vehicle denotes a vehicle that can move without operations of a user or with a minimum level of operations of a user.

For example, technologies for autonomous driving may include a technology for keeping a vehicle in the lane being used by the vehicle, a technology such as adaptive cruise control (ACC) for automatically controlling speed of a vehicle, a technology for allowing a vehicle to move autonomously along a determined path, a technology for setting a path automatically and for allowing a vehicle to move when a destination is set, and the like.

A vehicle may include a vehicle equipped only with an internal combustion engine, a hybrid vehicle equipped with an internal combustion engine and an electric motor, and an electric vehicle equipped only with an electric motor. Additionally, the vehicle may include a train, a motor cycle and the like in addition to an automobile.

In the case, an autonomous vehicle may be viewed as a robot having the function of autonomous driving.

Below, an example of basic operations for communication between an autonomous vehicle and a 5G network with reference to FIG. 1. For convenience of description, the autonomous vehicle is referred to as a “vehicle”.

The vehicle may transmit specific information to a 5G network (S1).

The specific information may include information in relation to autonomous driving.

The information on autonomous driving may be information directly related to control of driving of the vehicle. For example, the information on autonomous driving may include one or more pieces of information of object data indicating an object near a vehicle, map data, vehicle state data, vehicle location data and driving plan data.

The information on autonomous driving may further include service information and the like required for autonomous driving. For example, specific information may include information on destinations input through user terminals, and information on safety levels of vehicles. The 5G network may determine whether to remotely control a vehicle (S2).

The 5G network may include a server or a module that performs remote control in relation to autonomous driving.

Additionally, the 5G network may transmit information (or signals) in relation to remote control to the vehicle (S3). The information in relation to remote control may be a signal directly applied to the vehicle, and may further include service information required for autonomous driving.

According to an embodiment, the vehicle may receive service information such as information on insurance for each section selected on a path, information on dangerous sections and the like, through a server connected to the 5G network, and on the basis of the received service information, may offer services in relation to autonomous driving.

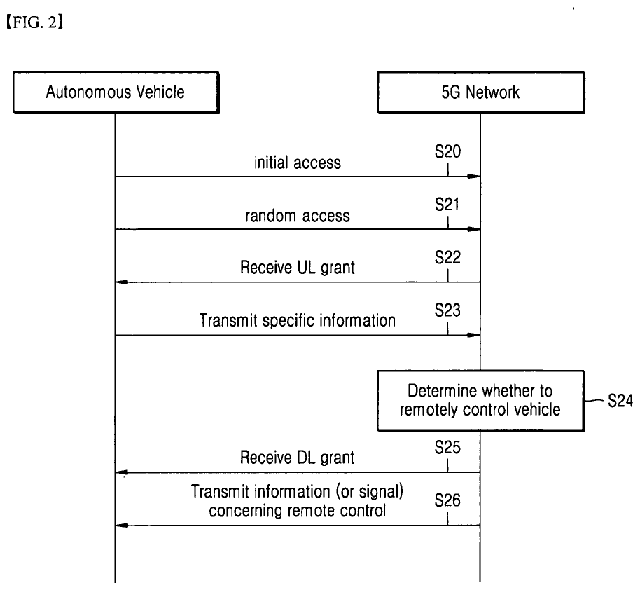

Below, a process required for 5G communication between the vehicle and the 5G network (e.g., the procedure of initial access of an autonomous vehicle to a 5G network and the like) to offer insurance services available for each section during autonomous driving is schematically described with reference to FIGS. 2 to 6.

FIG. 2 is a view illustrating an example of application operations of a vehicle and a 5G network in a 5G communication system.

The vehicle may perform initial access to the 5G network (S20).

The procedure of initial access may include cell search for requiring downlink (DL) operation, a process of acquiring system information, and the like.

The vehicle may perform random access to the 5G network (S21).

The process of random access may include preamble transmission, reception of a random access response and the like to acquire uplink synchronization or to transmit UL data.

The 5G network may transmit a UL grant for scheduling transmission of specific information to the vehicle (S22).

The process of receiving the UL grant may include a process of receiving scheduling of time/frequency resources to transmit the UL data to the 5G network.

The vehicle may transmit specific information to the 5G network on the basis of the UL grant (S23).

The 5G network may determine whether to remotely control the vehicle (S24).

The vehicle may receive a DL grant through a physical downlink control channel (PDCCH) to receive a response to specific information from the 5G network (S25).

The 5G network may transmit information (or signals) in relation to remote control to the driving vehicle on the basis of the DL grant (S26).

FIG. 2 illustrates an example, in which the process of initial access and/or the process of random access of an autonomous vehicle to a 5G network and the process of receiving a downlink grant are combined, through steps 20 to 26. However, the present disclosure is not limited to what is illustrated.

For example, the process of initial access and/or random access may be performed through steps 20, 22, 23, 24, and 26. Additionally, the process of initial access and/or random access may be performed through steps 21, 22, 23, 24 and 26. Further, the process of combining AI operation and reception of a downlink grant may be performed through steps 23, 24, 25, and 26.

Furthermore, FIG. 2 illustrates that operations of a vehicle performing autonomous driving are controlled through steps 20 to 26. However, the present disclosure is not limited to what is illustrated.

For example, operations of a vehicle that autonomously moves may be performed by selectionally combining steps 20, 21, 22 and 25, and steps 23 and 26. Additionally, operations of a vehicle that autonomously moves may be comprised of steps 21, 22, 23 and 26. Further, operations of a vehicle that autonomously moves may be comprised of steps 20, 21, 23, and 26. Furthermore, operations of a vehicle that autonomously moves may be comprised of steps 22, 23, 24, and 26.

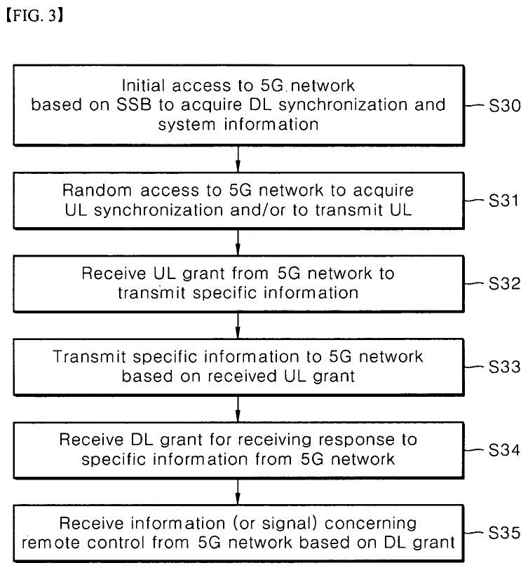

FIGS. 3 to 6 are views illustrating an example of operations of an autonomous vehicle using 5G communication.

Referring to FIG. 3, a vehicle including an autonomous driving module may perform initial access to a 5G network on the basis of a synchronization signal block (SSB) to acquire DL synchronization and system information (S30).

The vehicle may perform random access to the 5G network to acquire UL synchronization and/or to transmit UL (S31).

The vehicle may receive a UL grant from the 5G network to transmit specific information (S32).

The vehicle may transmit the specific information to the 5G network on the basis of the UL grant (S33).

The vehicle may receive a DL grant for receiving a response to the specific information from the 5G network (S34).

The vehicle may receive information (or signals) in relation to remote control from the 5G network on the basis of the DL grant (S35).

In step 30, a process of beam management (BM) may be added. Additionally, in step 31, a process of beam failure recovery may be added in relation to physical random access channel (PRACH) transmissions. Further, in step 32, a QCL relationship may be added in relation to a direction in which PDCCH beams including UL grants are received. Furthermore, in step 33, a QCL relationship may be added in relation to a direction in which physical uplink control channel (PUCCH)/physical uplink shared channel (PUSCH) beams including specific information are transmitted. Furthermore, in step 34, a QCL relationship may be added in relation to a direction in which PDCCH beams including DL grants are received.

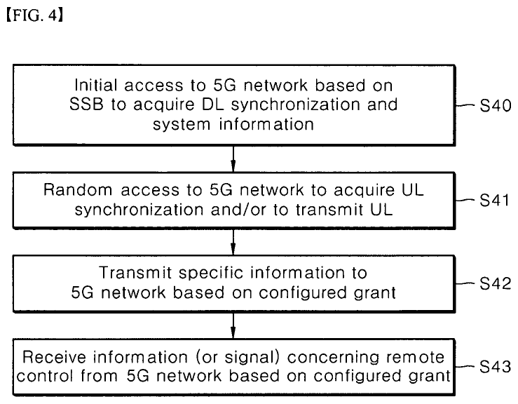

Referring to FIG. 4, a vehicle may perform initial access to a 5G network on the basis of SSB to acquire DL synchronization and system information (S40).

The vehicle may perform random access to the 5G network to acquire UL synchronization and/or to transmit UL (S41).

The vehicle may transmit specific information to the 5G network on the basis of a configured grant (S42). In other words, the vehicle may also transmit specific information to the 5G network on the basis of the configured grant instead of receiving a UL grant from the 5G network.

The vehicle may receive information (or signals) in relation to remote control from the 5G network on the basis of the configured grant (S43).

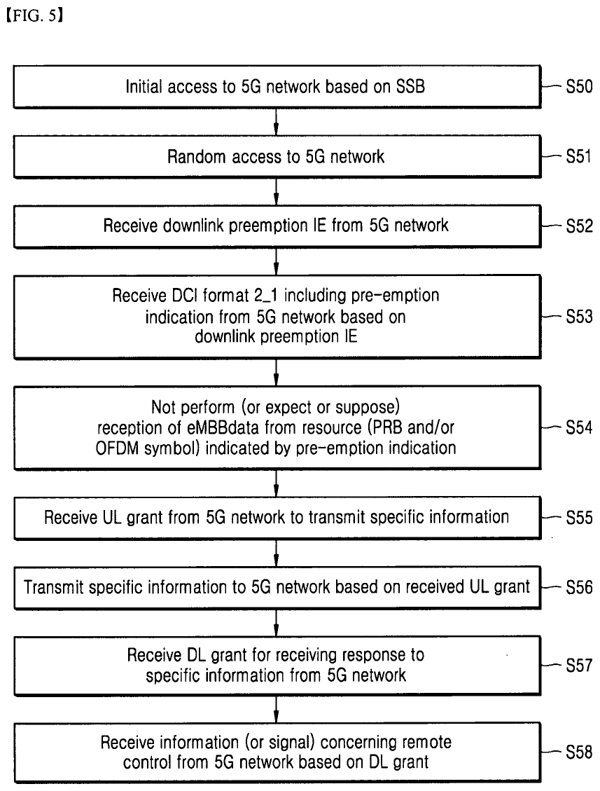

Referring to FIG. 5, a vehicle may perform initial access to a 5G network on the basis of SSB to acquire DL synchronization and system information (S50).

The vehicle may perform random access to the 5G network to acquire UL synchronization and/or to transmit UL (S51).

The vehicle may receive a downlink preemption IE from the 5G network (S52).

The vehicle may receive DCI format 2_1 including preemption indication from the 5G network on the basis of the downlink preemption IE (S53).

The vehicle may not perform (or expect or suppose) reception of eMBB data in resources (PRB and/or OFDM symbols) indicated by preemption indication (S54).

The vehicle may receive a UL grant from the 5G network to transmit specific information (S55).

The vehicle may transmit the specific information to the 5G network on the basis of the UL grant (S56).

The vehicle may receive a DL grant for receiving a response to the specific information from the 5G network (S57).

The vehicle may receive information (or signals) in relation to remote control from the 5G network on the basis of the DL grant (S58).

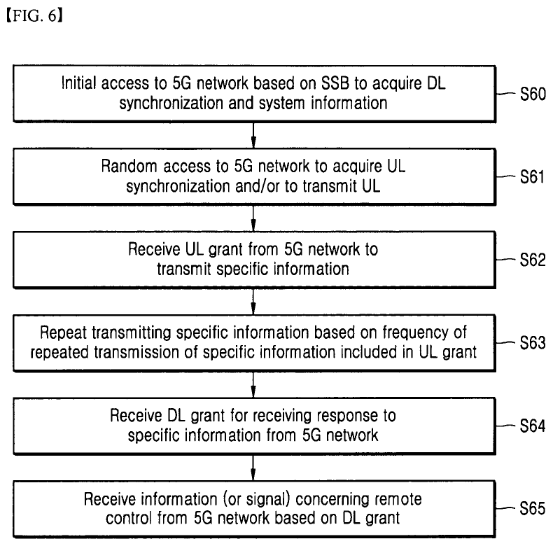

Referring to FIG. 6, a vehicle may perform initial access to a 5G network to acquire DL synchronization and system information on the basis of SSB (S60).

The vehicle may perform random access to the 5G network to acquire UL synchronization and/or to transmit UL (S61).

The vehicle may receive a UL grant from the 5G network to transmit specific information (S62). Here, the UL grant may include information about the number of repetitions of transmission of the specific information.

The vehicle may repeat transmitting specific information on the basis of the information on frequencies of repeated transmissions of specific information (S63).

Repeated transmissions of specific information may be performed through frequency hopping. First specific information may be transmitted by a first frequency resource, and second specific information may be transmitted by a second frequency resource.

Specific information may be transmitted through a narrowband of 6 resource block (RB) or 1 resource block (RB).

The vehicle may receive a DL grant for receiving a response to the specific information from the 5G network (S64).

The vehicle may receive information (or signals) in relation to remote control from the 5G network on the basis of the DL grant (S65).

The above-described 5G communication technology may be applied to what is described below, and may make up for technical features presented in this specification to make the technical features more specific and clear.

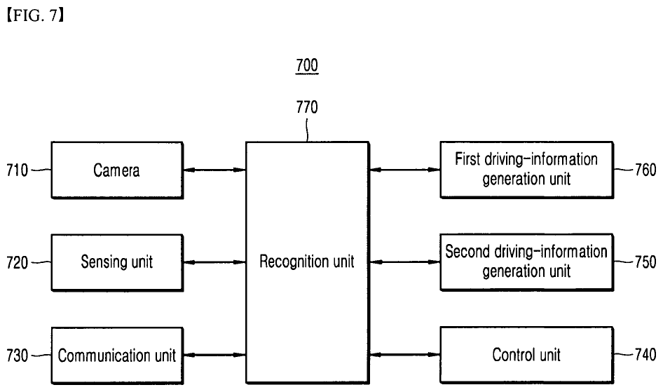

FIG. 7 is a schematic block diagram illustrating an autonomous vehicle according to an embodiment.

The autonomous vehicle 700 is a vehicle that receives a control instruction from an external control server through a 5G network, and that performs normal driving when a collision is not predicted and performs collision-prediction driving when a collision is predicted, using information sensed by the autonomous vehicle 700 together with the control instruction. For convenience of description, an “autonomous vehicle” is referred to as a “vehicle”.

Referring to FIG. 7, a vehicle 700 includes a camera 710, a sensing unit 720, a communication unit (or communicator) 730, a recognition unit (or recognizer) 740, a first driving-information generation unit (or first driving-information generator) 750, a second driving-information generation unit (or second driving-information generator) 760 and a control unit (or controller) 770.

In this case, the recognition unit 740, the first driving-information generation unit 750, the second driving-information generation unit 760 and the control unit 770 may be processor-based modules. The processor may be any one of a central processing unit (CPU), an application processor or a communication processor. Additionally, the recognition unit 740, the first driving-information generation unit 750, the second driving-information generation unit 760 and the control unit 770 may also be configured as an additional control apparatus.

Below, the function of each of the components is specifically described.

The camera 710 is disposed outside the vehicle 700 and acquires real-time image frames of surroundings of the vehicle 700.

In this case, the camera 710 may acquire an image frame within a preset angle of view and may adjust a frame rate.

The sensing unit 720 may include at least one sensor, and senses specific information on an external environment of the vehicle 700. As an example, the sensing unit 720 may include a lidar sensor, a rator sensor, an infrared sensor, an ultrasonic sensor, an RF sensor and the like for measuring a distance from the sensing unit to an object (i.e. another vehicle, a person, a hill and the like) placed near the vehicle 700, and may include various sensors such as a geomagnetic sensor, an inertial sensor, a photo sensor and the like.

The communication unit 730 performs communication with a control server and another vehicle. Specifically, the communication unit 730 may perform communication using a 5G network.

The recognition unit 740 recognizes first information that is state information on at least one object near the vehicle 700, second information that is state information on at least one space near the vehicle 700, and third information that is state information on at least one line near the vehicle 700, in real time, on the basis of the real-time image frame. Additionally, information sensed by the sensing unit 720 may be further used for recognition.

The recognition unit 740 may include an object recognition unit, a space recognition unit and a line recognition unit.

The object recognition unit recognizes first information that is state information on at least one object.

The state information on an object includes type information and location information on the object. Types of objects include a person and another vehicle near the road. Locations of objects are locations of the objects in an image frame.

The object recognition unit may calculate state information on an object using a first algorithm model based on an artificial neural network.

The space recognition unit recognizes second information that is state information on at least one space near the vehicle 700.

The state information on a space includes type information and location information on the space. Types of spaces include a road and a sidewalk. Locations of spaces are locations of the spaces in an image frame.

The space recognition unit may calculate state information on a space using a second algorithm model based on an artificial neural network.

The line recognition unit recognizes third information that is state information on at least one line marked on the road used by the vehicle 700.

The state information on a line includes type information and location information on the line. Types of lines are defined according to colors and forms. Locations of lines are locations of the lines in an image frame.

The line recognition unit may calculate state information on a line using a third algorithm model based on an artificial neural network.

The first driving-information generation unit 750 generates first driving information for normal driving of the vehicle 700 by combining the first information, the second information and the third information.

The second driving-information generation unit 760 predicts the occurrence of a collision of the vehicle 700 using the first information, the second information and the third information, and generates second driving information for collision-prevention driving when the collision occurrence is predicted.

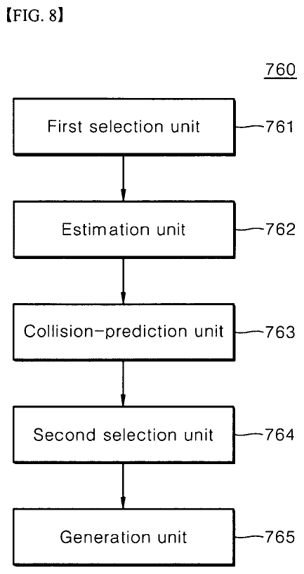

FIG. 8 is a view illustrating a schematic configuration of a second driving-information generation unit 760 according to an embodiment.

Referring to FIG. 8, the second driving-information generation unit 760 includes a first selection unit 761, an estimation unit 762, a collision-prediction unit 763, an second selection unit 764 and a generation unit 765.

The first selection unit 761 selects at least one candidate collision-avoidance area that is an area for preventing a collision of the vehicle 700, using the second information and the third information. The candidate collision-avoidance area is defined as a candidate for an avoidance area for preventing the vehicle 700 from colliding with another vehicle.

The estimation unit 762 estimates movements of at least one object using the first information.

The collision-prediction unit 763 predicts the occurrence of a collision between the vehicle 700 and at least one object on the basis of the estimated movements of at least one object.

The second selection unit 764 selects for a collision-avoidance area among one or more candidate collision-avoidance areas on the basis of the estimated movements of at least one object when a collision of the vehicle 700 is predicted.

The generation unit 765 generates second driving information included in the selected collision-avoidance area.

Referring back to FIG. 7, the control unit 770 controls driving of the vehicle 700 using any one of the first driving information and the second driving information. That is, the control unit 770 controls driving of the vehicle 700 using the first driving information at the time of normal driving, while controlling driving of the vehicle 700 using the second driving information when a collision of the vehicle 700 is predicted.

Though not illustrated in FIG. 7, the vehicle 700 may further include head lights and a sound-making device.

Below, a method of autonomous driving for preventing a collision of a vehicle 700 is specifically described with reference to the following drawings.

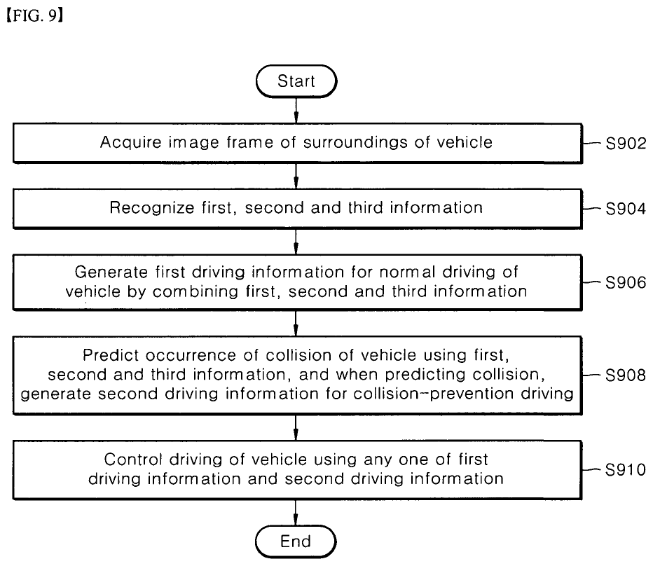

FIG. 9 is a flow chart illustrating a method for autonomous driving of a vehicle 700 according to an embodiment. Below, the function of each component is specifically described.

First, in step 902, a camera 710 acquires a real-time image frame of surroundings of the vehicle 700.

Next, in step 904, a recognition unit 740 recognizes first information, second information and third information in real time.

Specifically, an object recognition unit in the recognition unit 740 recognizes the first information that is state information on at least one object, in real time.

The state information on an object includes type information and location information on the object.

Types of objects include a person, another vehicle and other objects near a road used by a vehicle. The recognition unit 740 may estimate probability of an object, and on the basis of the probability, may recognize the type of the object.

Locations of objects may be locations of the objects in image frames.

According to an embodiment, the object recognition unit may calculate state information on an object using a first algorithm model based on an artificial neural network.

Additionally, a space recognition unit in the recognition unit 740 recognizes the state of at least one space near the vehicle 700 in real time. Herein, at least one space is a space that belongs to a road.

The state information on a space may include type information and location information on the space.

Types of spaces may include roads and sidewalks. The space recognition unit may estimate probability of a space, and on the basis of the probability, may recognize the type of the object.

Locations of spaces denote locations of the spaces in image frames.

According to an embodiment, the space recognition unit may calculate the state of a space using a second algorithm model based on an artificial neural network.

Additionally, a line recognition unit in the recognition unit 740 recognizes the state of at least one line marked on a road used by the vehicle 700 in real time.

The states of lines may include types and locations of the lines.

Lines are classified into a plurality of types of lines on the basis of colors and forms. As an example, lines may be classified as white lines, white dotted lines, double white lines, double white lines/dotted lines, yellow lines, yellow dotted lines, double yellow lines, double yellow lines/dotted lines, blue lines, blue dotted lines, double blue dotted lines and the like.

Locations of lines denote locations of the lines in image frames.

According to an embodiment, the line recognition unit may calculate state information on an object in a space using a third algorithm model based on an artificial neural network.

The above-described first algorithm model, second algorithm model, and third algorithm model based on artificial neural networks, as an algorithm model based on a deep neural network (DNN), and may be convolutional neural networks (CNN) and algorithms derived from CNNs.

Specific description in relation to this is provided hereunder.

Artificial intelligence (AI) is a type of computer engineering and information technology that develop a method for giving a computer the abilities to think, to learn, to be self-developed and the like, which may be performed by humans, and allows computers to mimic human intelligence.

AI does not exist in itself, but is directly and indirectly linked to other fields of computer science. In a modern society, attempts to introduce the factor of artificial intelligence to various fields of information technology and to use the factor to solve problems in these fields have been made.

Machine learning is part of artificial intelligence and is an area that studies a technology for giving a computer an ability to learn without explicit programs.

Specifically, machine learning is a technology for studying and establishing a system that may perform learning and prediction and may improve its performance based on empirical data, and an algorithm for the system. Algorithms of machine learning involve establishing a specific model to draw prediction or determination based on input data rather than performing functions based on static program instructions that are strictly determined.

The terms “machine learning” and “mechanical learning” are mixedly used.

Various machine learning algorithms have been developed on the basis of how to classify data in machine learning. Examples of machine learning algorithms include a decision tree, a Bayesian network, a support-vector machine (SVM), an artificial neural network (ANN) and the like.

Specifically, the artificial neural network models a theory of the operation of biological neurons and a connection between neurons, and is an information processing system in which a plurality of neurons that are nodes or processing elements are connected in the form of a layer.

That is, the artificial neural network is a model used in machine learning, and is a statistical learning algorithm, inspired by a neural network (brain in the central nerve system of animals) in biology, in machine learning and cognitive science.

Specifically, the artificial neural network may include a plurality of layers, and each of the layers may include a plurality of neurons. Additionally, the artificial neural network may include a synapse that connects a neuron and a neuron. That is, the artificial neural network may denote a model as a whole, in which artificial neurons, forming a network through a combination of synapses, have the ability to solve a problem by changing the intensity of the connection of synapses through learning.

The terms “artificial neural network” and “neural network” may be mixedly used, the terms “neuron” and “node” may be mixedly used, and the terms “synapse” and “edge” may be mixedly used.

The artificial neural network may be generally defined by an activation function for generating an output value from a total of the three following factors, i.e., (1) a pattern of a connection between neurons of other layers, (2) the process of learning the renewal of weights of synapses, and (3) a weight of an input received from a previous layer.

The artificial neural network may include network models such as a deep neural network (DNN), a recurrent neural network (RNN), a bidirectional recurrent deep neural network (BRDNN), a multilayer perceptron (MLP), a convolutional neural network (CNN) but may not be limited.

The artificial neural network is classified as a single-layer neural network, and a multi-layer neural network based on the number of layers.

A regular single-layer neural network is comprised of an input layer and an output layer.

A regular multi-layer neural network is comprised of an input layer, one or more hidden layers and an output layer.

The input layer is a layer that accepts external data, and the number of neurons of the input layer is the same as the number of input variables.

The hidden layer is disposed between the input layer and the output layer, receives signals from the input layer to extract features, and delivers the signals to the output layer.

The output layer receives the signals from the hidden layer and outputs an output value based on the received signals. Input signals between neurons are multiplied by each weight (intensity of a connection) and then added up. When the total is greater than a threshold of the neurons, the neurons are activated and output an output value acquired through an activation function.

The deep neural network, including a plurality of hidden layers between the input layer and the output layer, may be a typical artificial neural network that implements deep learning, a type of machine learning.

The terms “deep learning” and “deep structured learning” may be mixedly used.

Artificial neural networks may be trained using training data. Training may denote a process of determining parameters of the artificial neural networks using learning data to achieve aims such as the classification, regression, clustering and the like of input data. Typical examples of parameters of the artificial neural network include weights of synapses or biases applied to neurons.

An artificial neural network trained using training data may classify or cluster input data based on patterns of the input data. In this specification, an artificial neural network trained using training data may be referred to as a trained model.

Next, learning methods of artificial neural networks are described.

Learning methods of an artificial neural network may be broadly classified as supervised learning, unsupervised learning, semi-supervised learning, and reinforcement learning.

Supervised learning is a way of machine learning for inferring a single function from training data. In this case, outputting continuous values among inferred functions is referred to as regression, and predicting and outputting classes of input vectors is referred to as classification. That is, in supervised learning, an artificial neural network is trained in the state in which a label is given to training data. The label denotes the correct answer (or result value) that has to be inferred by an artificial neural network when training data is input to the artificial neural network.

Unsupervised learning is a way of machine learning, and a label is not given to training data. Specifically, unsupervised learning is a way of learning in which an artificial neural network is trained to find out patterns from training data itself rather than a connection between the training data and labels corresponding to the training data to classify the training data.

Semi-supervised learning is a type of machine learning, and may denote a way of learning with all the training data that are given labels or that are not. As a type of the method of semi-supervised learning, after labels of training data that are not given labels are inferred, learning is performed using the inferred labels. The method may be useful when huge costs are incurred for labeling

Reinforcement learning is a theory that the best way may be found out through experience without data if the environment in which an agent may determine what to do every moment is given.

Referring to the above description, algorithm models based on an artificial neural network for recognizing an object, a space and a line according to the present disclosure includes an input layer comprised of input nodes, an output layer comprised of output nodes, and one or more hidden layers disposed between the input layer and the output layer and comprised of hidden nodes. In this case, the algorithm model is trained by learning data, and through learning, weights of edges that connect nodes, and biases of nodes may be updated.

Additionally, an image frame is input to each input layer of the algorithm models. Further, the type and location of at least one object are output to an output layer of a first algorithm model, the type and location of at least one space are output to an output layer of a second algorithm model, and the type and location of at least one line are output to an output layer of a third algorithm model.

Referring back to FIG. 9, in step 906, the first driving-information generation unit 750 generates first driving information for normal driving of the vehicle 700 in real time by combining the first information, the second information, and the third information.

That is, the first driving-information generation unit 750 generates first driving information for controlling the driving of the vehicle 700 in a situation in which a collision does not occur.

As an example, the first driving-information generation unit 750 may convert the first information into a first two-dimensional map (e.g., a two-dimensional bird's-eye-view map), may convert the second information into a second two-dimensional map, and may convert the third information into a third two-dimensional map, and then may generate the first driving information using the first map, the second map and the third map.

In step 908, the second driving-information generation unit 760 predicts the occurrence of a collision of the vehicle 700 using the first information, the second information, and the third information, and generates second driving information for collision-prevention driving when the collision occurrence is predicted.

That is, the operation (S908) of the second driving-information generation unit 760 is performed separately in addition to the operation (S906) of the first driving-information generation unit 750. The second driving information for predicting a collision and for collision-prevention driving is generated using the first information, the second information and the third information that are not converted by the first driving-information generation unit 750. The second driving information is generated using the non-converted first, second and third information, thereby providing fast predictions about a collision.

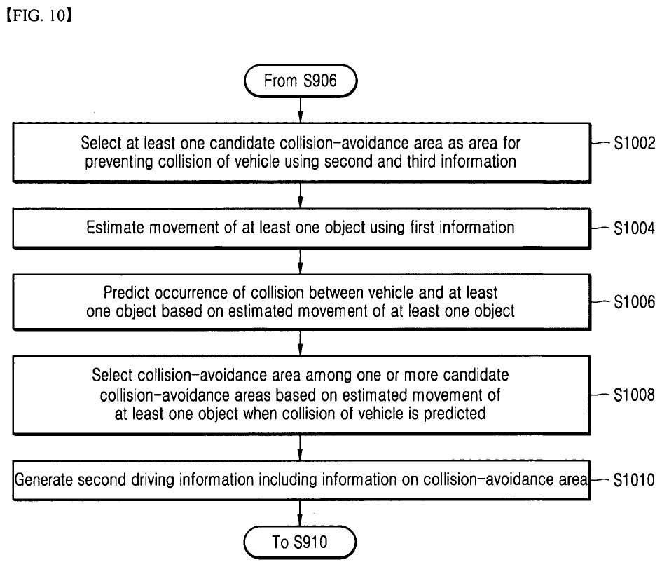

FIG. 10 is a flow chart specifically illustrating step 908 in FIG. 9.

In step 1002, a first selection unit 761 selects at least one candidate collision-avoidance that is an area for preventing a collision of the vehicle 700 using the second information and the third information.

The candidate collision-avoidance area is defined as an avoidance area for preventing the vehicle 700 from colliding with another vehicle, and the first selection unit 761 selects a candidate collision-avoidance area for avoiding a collision of the vehicle 700 on the basis of state information on at least one space and state information on at least one line.

To this end, the first selection unit 761 determines the type of at least one road using state information on at least one space and state information on at least one line, and on the basis of the type of at least one road, selects at least one candidate collision-avoidance area. In this case, at least one line is mapped in at least one space, and the type of at least one road is determined.

As an example, types of roads may include bus lanes, bicycle lanes, regular lanes, sidewalks, paths for pedestrians/bicycles, and the like.

According to an embodiment, the candidate collision-avoidance area may include an area on a first road that is a road used by a vehicle 700 in compliance with the traffic law, and an area on a second road that is a road not used by a vehicle 700 in compliance with the traffic law.

Specifically, a vehicle 700 generally moves in compliance with the traffic law. In this case, a road, which may be used by a vehicle in compliance with the traffic law, includes road A that is a road on which a safe distance between vehicles is ensured back and forth, and road B that is a road in which a safe distance between vehicles is not ensured back and forth, or a road which may not be used by a vehicle 700 because another object is on the road even though a safe distance between vehicles is ensured.

Additionally, a vehicle 700 may move on road C that may be used by a vehicle like road A despite non-compliance with the traffic law. As an example, road C may be the opposite lane with respect to the center line, a sidewalk, a path for bicycles, a crosswalk across and the like.

Accordingly, the first selection unit 761 may select an area on the first road that may be used by a vehicle 700 in compliance with the traffic law like road A, and an area of the second road that may not be used by a vehicle 700 in compliance with the traffic law but may be used by a vehicle 700 to avoid a collision like road C as at least one candidate collision-avoidance area.

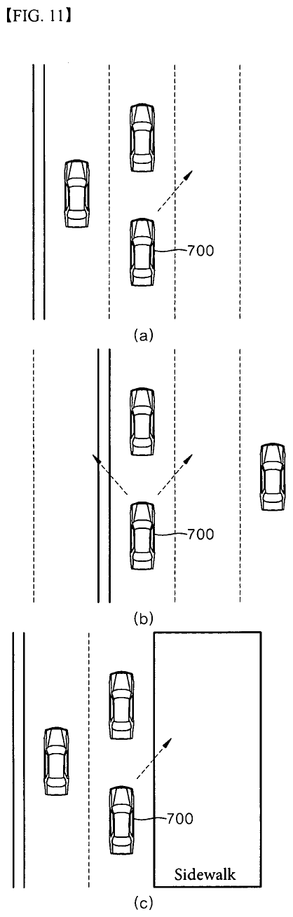

FIG. 11 illustrates an example of a candidate collision-avoidance area.

FIG. 11(a) illustrates that an area on the first road on the right side of the vehicle 700 is selected as a candidate collision-avoidance area, FIG. 11(b) illustrates that an area on the first road on the right side of the vehicle 700 and the opposite lane with respect to the center line are selected as candidate collision-avoidance areas, and FIG. 11(c) illustrates a sidewalk is selected as a candidate collision-avoidance area.

Referring back to FIG. 10, in step 1004, an estimation unit 762 estimates movements of at least one object using the first information.

That is, the estimation unit 762 may estimate speeds of an object on the basis of location information on the object, and may estimate movements of the object on the basis of the estimated speeds.

Speeds of an object may be calculated using an algorithm (e.g., an extended Kalman filter) capable of estimating speeds of an object on the basis of the location of the object on an image frame.

In step 1006, a collision-prediction unit 763 predicts the occurrence of a collision between the vehicle 700 and at least one object on the basis of the estimated movements of at least one object.

According to an embodiment, the collision-prediction unit 763 may predict a collision using movement information according to the state of at least one object and an expected braking distance of the vehicle 700.

As an example, when a distance between the position of the object derived from the movement information and the position of the vehicle 700 is longer than an expected braking distance of the vehicle 700, a prediction that there would be no collision of the vehicle 700 is made.

As another example, when a distance between the position of the object derived from the movement information and the position of the vehicle 700 is shorter than an expected braking distance of the vehicle 700, a prediction that there would be collision of the vehicle 700 is made.

Additionally, in step 1008, an second selection unit 764 may select for a collision-avoidance area among one or more candidate collision-avoidance areas on the basis of the estimated movements of at least one object when the vehicle 700 is expected to collide.

That is, the second selection unit 764 may select at least one of candidate collision-avoidance areas with no object among one or more candidate collision-avoidance areas, and then may select one of the at least one of candidate collision-avoidance area as a collision-avoidance area.

According to an embodiment, the second selection unit 764 may select an area on the first road as a collision-avoidance area when the at least one candidate collision-avoidance area includes the area on the first road. and may select an area on the second road as a collision-avoidance area when the at least one candidate collision-avoidance area includes only the area on the second road.

That is, when at least one collision-avoidance area includes an area on the first road and an area on the second road, the second selection unit 764 selects the area on the first road. Additionally, when at least one collision-avoidance area includes only at least one area on the second road, the second selection unit 764 selects any one of one or more areas on the second road. That is, in the case in which there is a collision-avoidance area in compliance with the traffic law, the second selection unit 764 selects a collision-avoidance area in compliance with the traffic law rather than another collision-avoidance area.

In step 1010, a generation unit 765 generates second driving information including information on a collision-avoidance area.

Referring back to FIG. 9, in step 910, a control unit 770 controls driving of the vehicle 700 using any one of the first driving information and the second driving information.

That is, the control unit 770 controls driving of the vehicle 700 using the first driving information at the time of normal driving. However, when a collision is predicted, the control unit 770 controls the driving of the vehicle 700 using the second driving information.

In summary, the present disclosure may preset an area to which a vehicle 700 has to move to avoid a collision through simple data before the collision in addition to generating the first driving information for regular autonomous driving, and when a collision is predicted, may prevent the collision by moving the vehicle 700 to the preset collision-avoidance area. That is, time spent on predicting a collision and performing an operation to avoid the collision may be minimized, thereby performing the operation of avoiding the collision fast and preventing the collision effectively.

A method for autonomous driving of the vehicle 700 for preventing a collision according to the present disclosure may prevent a secondary collision that can occur when the vehicle 700 moves to a collision-avoidance area.

Specifically, when the vehicle 700 moves to a collision-avoidance area, the control unit 770 may control the headlights of the vehicle 700 such that the headlights are turned on/off on a regular basis, may control the sound-making device of the vehicle 700 such that sounds are output to the sound-making device, or may control the communication unit 730 to send a message that the vehicle 700 is moving to an area on the second road to another vehicle near the vehicle 700.

What has been described above may be effectively applied when the vehicle 700 is moving to an area on the second road that may not be moved by the vehicle 700 in compliance with the traffic law, to avoid a collision.

Thus, a secondary collision that can be caused by the operation of avoiding a collision may be prevented.

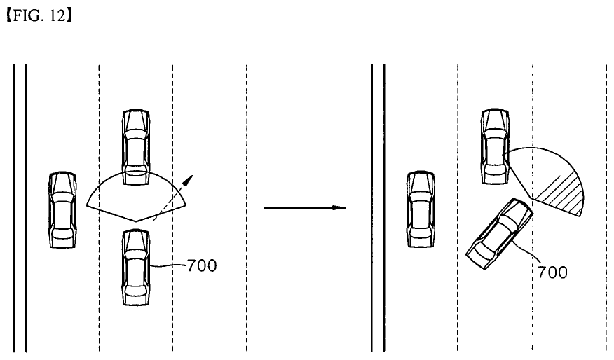

Additionally, there are times when information on at least part of the selected collision-avoidance areas is not included in an image frame that is acquired before a collision is predicted. This case is illustrated in FIG. 12.

Referring to FIG. 12, when the vehicle 700 moves to a lane on the right side to avoid a collision, information on a part of an area to which the vehicle 700 moves may not be included in an image frame that is acquired before the collision is predicted. Accordingly, a secondary collision may occur because of the absence of the information.

In this case, the control unit 770 may increase an image frame rate of a camera 710 to acquire the information as fast as possible.

As an example, the camera 710 may acquire an image frame at speeds of 30 fps to 90 fps. On the assumption that the camera 710 acquires an image frame at a speed of 30 fps at the time of normal driving, when the vehicle 700 moves to a collision-avoidance area, the control unit 770 may increase an image frame rate of the camera 710 from 30 fps to 90 fps. Thus, information may be acquired fast.

There are times when an increased image frame rate is greater than an image frame rate that can be processed by the recognition unit 740 at a maximum level. As an example, a maximum image frame rate processed by the recognition unit 740 may be 60 fps, and an increased image frame rate of the camera 710 may be 90 fps.

In this case, the control unit 770 may determine the state of at least one object and the type of at least one road using a part of the acquired image frame. In this case, the part of the image frame may be a part located in a direction opposite to a direction of an object expected to collide.

As an example, when an image frame rate of the recognition unit 740 is 60 fps, and an increased image frame rate of the camera 710 is 90 fps, the recognition unit 740 may not process 30 image frames per one second.

The recognition unit 740 may process 30 of 90 image frames per second using full image frame to determine the state of an object and the type of a road, and may process 60 of the 90 image frames using half image frames to determine the state of an object and the type of a road. That is, when three image frames are received successively, a first image frame uses full image frame, and the rest two image frames may use half image frames. In this case, half image frame may be in a direction opposite to a direction of the object expected to collide.

In summary, the present disclosure may set an area to which the vehicle has to move to avoid a collision, before the collision occurs, thereby minimizing time spent on predicting the collision and performing the operation of avoiding the collision, and performing the operation of avoiding the collision fast. Additionally, when the vehicle 700 moves to a collision-avoidance area, the present disclosure may increase an image frame rate of the camera 710 to prevent a secondary collision.

Although in embodiments, all the elements that constitute the embodiments of the present disclosure are described as being coupled to one or as being coupled to one so as to operate, the disclosure is not limited to the embodiments. One or more of all the elements may be optionally coupled to operate within the scope of the present disclosure. Additionally, each of the elements may be implemented as single independent hardware, or some or all of the elements may be optionally combined and implemented as a computer program that includes a program module for performing some or all of the combined functions in single hardware or a plurality of hardware. Codes or segments that constitute the computer program may be readily inferred by one having ordinary skill in the art. The computer program is recorded on computer-readable media and read and executed by a computer to implement the embodiments. Storage media that store computer programs includes storage media magnetic recording media, optical recording media, and semiconductor recording devices. Additionally, the computer program that embodies the embodiments includes a program module that is transmitted in real time through an external device.

The embodiments of the present disclosure have been described. However, the embodiments may be changed and modified in different forms by one having ordinary skill in the art. Thus, it should be understood that the changes and modifications are also included within the scope of the present disclosure.

What is claimed is:

1. An autonomous vehicle, comprising:
a camera configured to acquire an image frame near a vehicle performing autonomous driving;
a recognizer configured to recognize first information that is state information on at least one object near the vehicle, second information that is state information on at least one space near the vehicle, and third information that is state information on at least one line near the vehicle, on the basis of the image frame;
a first driving-information generator configured to generate first driving information for normal driving of the vehicle by combining the first information, the second information and the third information;
a second driving-information generator configured to predict the occurrence of a collision of the vehicle using the first information, the second information and the third information, and to generate second driving information for collision-prevention driving when the collision occurrence is predicted; and
a controller configured to control driving of the vehicle using the second driving information when the collision occurrence is predicted, and configured to control driving of the vehicle using the first driving information when the collision occurrence is not predicted.

2. The autonomous vehicle of claim 1, the second driving-information generator, comprising:
a first selector configured to select one or more candidate collision-avoidance areas that are an area for preventing a collision of the vehicle using the second information and the third information;
an estimator configured to estimate movements of the at least one object using the first information;
a collision-predictor configured to predict the occurrence of a collision between the vehicle and the at least one object on the basis of the estimated movements of the at least one object;
an second selector configured to select a collision-avoidance area among the one or more candidate collision-avoidance areas on the basis of the estimated movements of the at least one object when the collision occurrence is predicted; and
a generator configured to generate the second driving information including information on the collision-avoidance area.

3. The autonomous vehicle of claim 2, wherein the first information includes a type and location of the object,
the second information includes a type and location of the space,
the third information includes a type and location of the line,
the type of the object includes a person and another vehicle; and
the type of the space includes a road and a sidewalk.

4. The autonomous vehicle of claim 2, wherein the vehicle moves in compliance with the traffic law in the case of normal driving, and
each of the one or more candidate collision-avoidance areas is any one of an area on a first road that is a road which can be moved by the vehicle in compliance with the traffic law, and an area on a second road that is a road which cannot be moved by the vehicle in compliance with the traffic law.

5. The autonomous vehicle of claim 4, wherein the second selector configured to select the area on the first road as the collision-avoidance area when the one or more candidate collision-avoidance areas include the area on the first road, and to select the area on the second road as the collision-avoidance area when the one or more candidate collision-avoidances area include only the area on the second road.

6. The autonomous vehicle of claim 2, wherein the camera acquires the image frame within a preset angle of view and adjusts a frame rate, and
when information on at least part of the collision-avoidance areas is not included in an image frame that is acquired before the collision is predicted, and the vehicle moves to the collision-avoidance area on the basis of the second driving information, the controller increases an image frame rate of the camera.

7. The autonomous vehicle of claim 6, wherein when the increased image frame rate is greater than an image frame rate that can be processed by the recognizer at a maximum level, the recognizer recognizes the first information, the second information, and the third information using a part of the image frame.

8. The autonomous vehicle of claim 7, wherein a part of the image frame is positioned in a direction opposite to a direction of the object expected to collide.

9. The autonomous vehicle of claim 1, wherein the autonomous vehicle further includes headlights, a sound-making device and a communicator, and
when the vehicle moves to the collision-avoidance area on the basis of second driving information, the controller controls the headlights such that the headlights are turned on/off on a regular basis, controls the sound-making device such that sounds are output to the sound-making device, or controls the communicator to send a message that the vehicle is moving to the collision-avoidance area to another vehicle near the vehicle.

10. The autonomous vehicle of claim 1, the recognizer, comprising:
an object recognizer configured to recognize the first information on the basis of a first algorithm model based on an artificial neural network;
a space recognizer configured to recognize the second information on the basis of a second algorithm model based on artificial neural network; and
a line recognizer configured to recognize the third information on the basis of a third algorithm model based on an artificial neural network, and
wherein each of the first algorithm model, the second algorithm model and the third algorithm model includes an input layer comprised of input nodes, an output layer comprised of output nodes, and one or more hidden layers disposed between the input layer and the output layer and comprised of hidden nodes, and weights of edges that connect nodes, and biases of nodes are updated through learning.

11. The autonomous vehicle of claim 10, wherein the image frame is input to each input layer of the first, second and third algorithm models,
a type, location and probability of the at least one object are output to the output layer of the first algorithm model,
a type, location and probability of the at least one space are output to the output layer of the second algorithm model, and
a type, location and probability of the at least one line are output to the output layer of the third algorithm model.

12. An apparatus for controlling an autonomous vehicle performing autonomous driving, comprising:
a recognizer configured to recognize first information that is state information on at least one object near the vehicle, second information that is state information on at least one space near the vehicle, and third information that is state information on at least one line near the vehicle, on the basis of an image frame acquired near the vehicle;
a first driving-information generator configured to generate first driving information for normal driving of the vehicle by combining the first information, the second information and the third information;
a second driving-information generator configured to predict the occurrence of a collision of the vehicle using the first information, the second information and the third information, and when predicting the collision, and configured to generate second driving information for collision-prevention driving; and
a controller configured to control driving of the vehicle using the second driving information when the collision occurrence is predicted, and to control driving of the vehicle using the first driving information when the collision occurrence is not predicted.

13. A method for controlling an autonomous vehicle, which is performed by an apparatus including a processor, comprising:
recognizing first information that is state information on at least one object near the vehicle, second information that state information on at least one space near the vehicle, and third information that is state information on at least one line near the vehicle, on the basis of an image frame acquired near the vehicle,
generating first driving information for normal driving of the vehicle by combining the first information, the second information and the third information;
predicting the occurrence of a collision of the vehicle using the first information, the second information and the third information and generating second driving information for collision-prevention driving when the collision occurrence is predicted; and
controlling driving of the vehicle using the second driving information when the collision occurrence is predicted, and controlling driving of the vehicle using the first driving information when the collision occurrence is not predicted.
